(19) United States
(12) Patent Application Publication
(10) Pub. No.: US 2008/0309496 A1
(43) Pub. Date: Dec. 18, 2008

(54) Method for Applying Radiofrequence Identification Transponders to Packaging Sheets, Transponders Support

(76) Inventor: Marc Mure, Wintzenheim (FR)

Correspondence Address: LUMEN PATENT FIRM, INC., 2345 YALE STREET, SECOND FLOOR, PALO ALTO, CA, 94306, US

(21) Appl. No.: 11/661,051

(22) PCT Filed: Aug. 12, 2005
(86) PCT No.: PCT/FR2005/002082

§ 371 Date: Dec. 14, 2007

(30) Foreign Application Priority Data
Aug. 20, 2004 (FR) 0451880

(51) Int. Cl. G08B 13/14

(52) U.S. Cl. 340/572.8

(57) ABSTRACT

The invention pertains to a method for applying radiofrequence identification transponders (14) to packaging sheets (120′), the sheets being obtained by cuts at intervals D in a band (120) of packaging material.

The method is characterized by the fact that
the said transponders (14) having previously been mounted on support (20) consisting of a strip-shaped flexible material with at least one transponder between each interval D, the intervals being defined by marks (26) on the support,
the said support (20) is laid on the band (120) of packaging material lengthwise, in such a manner that the transponders (14) are placed on the band according to the said interval D,
the transponders (14) are secured to the material, and
the band (120) of packaging material is cut into packaging sheets (120′) with respect to the said marks (26).

The invention also covers the transponders support (14).

The method of the invention presents the advantage of simple, effective and economical placement of transponders on a sheet such as corrugated cardboard, for example on corrugating machine.

The present invention relates to the field of packaging, in particular in corrugated cardboard, and pertains to the identification thereof as well as, if appropriate, the identification of the content thereof.

To identify an object or an item of merchandise, the so-called bar code technique has long been used. A label comprising the identification code of the object in the form of bars is read by an appropriate optical apparatus, and the information thus read can thereafter be processed. This technique is now losing ground, for numerous applications in which, for example, one seeks to improve the tracking of flows of merchandise or else the traceability of products, to electronic radiofrequence identification labels that are dubbed electronic labels, radiofrequence labels or RFID (Radio Frequence Identification Device) labels.

The system comprises labels that are affixed to the objects to be tracked and a reader. The electronic labels generally consist of a label-shaped support on which a radiofrequence identification transponder is mounted. The latter consists of electronic components, taking the form in particular of a chip, and of an antenna. The electronic components comprise a means for emitting and receiving electromagnetic signals, linked to the antenna and associated with a circuit for processing these signals with an information storage capacity. The reader, when it is placed in proximity to the object, emits a signal at a radio frequency to which the reception circuit of the label reacts. The latter, in return, emits a signal modulated with its own information, which is picked up by the reader. There exist passive labels which do nothing but react in response to the reception of a signal at an appropriate frequency and active labels which incorporate an energy source and can emit a signal by themselves.

Electronic labels present the advantage of being able to store a large amount of information and of being able to be read remotely. They do not need to be seen by the reader. They are furthermore of small thickness, of the order of a millimetre, and small surface area, of the order of a few centimetres square.

Labels incorporating the transponder, with the antenna and the electronic components on one and the same card-shaped support for example, are found on the market. The cards can be individual, strung together or else secured to a support band so as to form a band of labels. A face of the band comprises a film of adhesive material, generally self-adhesive or heat-activatable. For the placement of the labels, they are separated one by one from the support band and placed on the surface of the objects to be branded, where they adhere.

For example, U.S. Pat. No. 6,019,865 describes a procedure for making and assembling electronic labels ready to be marketed on the basis of prefabricated transponders. The transponder is deposited on a plane and flexible support, coated with a film of heat-sensitive adhesive material, and the whole is transferred to a printing module with a heating head. Information is thus printed on the surface of the support while activating the adhesive. It is possible to cut the support into individual labels or else deliver the whole as a roll, the user cutting them himself.

When dealing with the fitting of electronic labels on a packaging material such as corrugated cardboard, during the production of the packaging, the problem of their automatic placement is encountered. The latter results from the necessity to perform this operation at a cost that is as low as possible on a large quantity of packaging units. Specifically, these electronic labels have an already high intrinsic cost; it is important furthermore not to slow down the packaging production line.

It has been proposed that the labels be deposited on the conversion machines, during the cutting of the cardboard panels to the shape of the packaging. This solution is however unwieldy to implement and of low reliability. It has also been proposed that the labels be incorporated during the production of corrugated cardboard, between a liner and the adjacent corrugated internal sheet. This operation is performed on the corrugating machine, as is described in U.S. Pat. No. 6,667,092. This solution does not seem to be compatible with the temperature resilience of the electronic components during the passage of the corrugated cardboard ply, the paper sheets once glued and assembled, through the heating tables of the corrugator.

The invention is aimed at a method for incorporating electronic radiofrequence identification transponders, in the form of labels or otherwise, on packaging sheets or panels, that is at one and the same time simple to implement and economical.

In accordance with the invention, the method for applying radiofrequence identification transponders to packaging sheets, the sheets being obtained by the transverse cutting at given intervals D of a band of packaging material, is characterized by the fact that
the said transponders having previously been mounted on a support consisting of a strip-shaped flexible material, with at least one transponder between each interval D, the intervals being defined by marks on the support,
the said support is laid on the band of packaging material lengthwise, in such a manner that the transponders are placed on the band according to the said interval D,
the transponders are secured to the material, and
the band of packaging material is cut into packaging sheets with respect to the said marks.

By the method of the invention, it suffices to prepare a support incorporating the transponders spaced apart according to an interval dependent on the longitudinal dimension of the packaging to be cut. Preferably, the support has been made into a roll and is unwound on the material. The already known application techniques for laying labels on a substrate are advantageously employed moreover. The substrate can be driven in a plane translational motion with respect to the means of application of the labels or else the said application means is itself in motion with respect to the substrate.

The transponders support which is for example a paper or a flexible plastic is preferably coated on a face with a film of adhesive material, and the labels incorporating a transponder are glued to it. The labels are applied and thus fixed in a simple manner to the band of packaging material together with the said labels support.

The cutting can be performed between two consecutive transponders. However it is also possible to envisage two or more transponders per interval so as to obtain a cut sheet with the said transponders. The sheet is thereafter itself cut into smaller packaging sheets, each comprising a single transponder.

In accordance with another embodiment, transponders exhibiting different frequency characteristics are disposed over one and the same interval. A packaging able to respond to different frequencies is ultimately obtained.

The invention finds a particularly advantageous application when the packaging material is corrugated cardboard. The labels are then preferably deposited on the cardboard when the latter is still on corrugating machine, in particular downstream of the station for assembling the elementary paper sheets constituting the corrugated cardboard ply.

On corrugating machine, there already exists, generally, when it is necessary to tailor the cutting of the cardboard ply with respect to patterns preprinted on a liner, a means of optical reading of marks printed between two consecutive patterns, on the basis of which means the cutting member is controlled. In accordance with the invention, this existing reading means is used by envisaging appropriate marks, made with ink for example, on the transponders support and by controlling the cutting of the band of packaging material with respect to these marks.

In accordance with a particular embodiment, the band of packaging material, initially of large breadth, being cut into at least two mutually parallel bands, of smaller breadth, a support with transponders is deposited on each of the said parallel bands, it being possible for the intervals to be equal or different according to demand.

The invention also pertains to the transponders support as such. It consists of a flexible, continuous and strip-shaped support, to which the transponders are fixed, possibly by way of labels, at a rate of at least one per interval D. The support preferably comprises an adhesive means for fixing the transponders or the labels to the packaging material. However, other fixing means, stapling, heat sealing are also conceivable.

The invention is now described in greater detail with reference to the appended drawings in which:

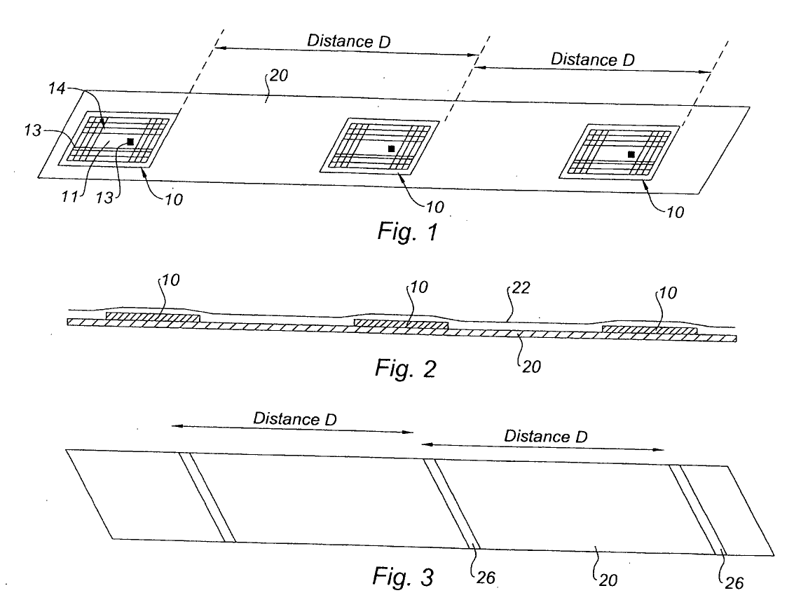

FIGS. 1, 2 and 3 show in a diagrammatic manner a support with the radiofrequence labels in accordance with an embodiment of the invention, respectively seen from above, from side-on and from below;

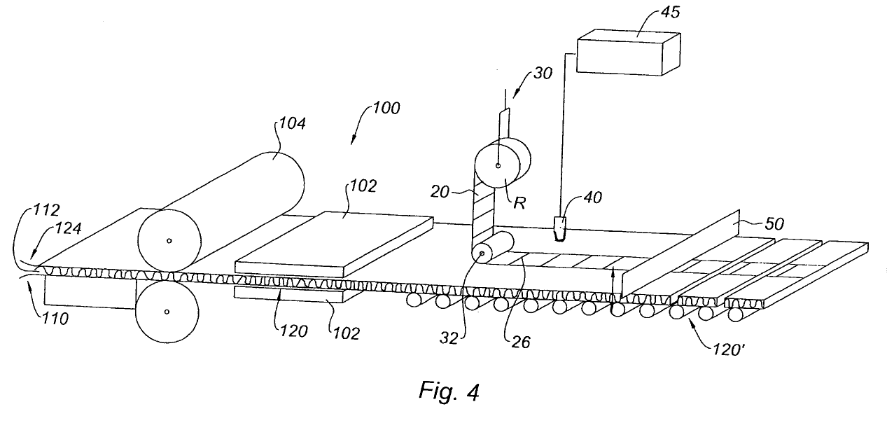

FIG. 4 is a diagram of an installation implementing the method of the invention.

As seen in FIGS. 1 to 3, electronic labels 10 have been placed on a strip-shaped support. Each label 10 comprises a paper or plastic card 11 on which the components such as an electronic chip 12 are mounted. An antenna 13 is linked electrically to the chip 12. The components and the antenna together form a radiofrequence identification transponder 14. It will be understood that the invention is not limited to the mounting of a radiofrequence identification label of particular type. It relates to any electronic label that can be applied to packaging, in particular cardboard packaging. The labels 10 are available on the market and are chosen as a function of the envisaged application, such as for example sales unit, transport carton or palette.

In accordance with a first embodiment of the invention, the labels 10 are mounted on a strip-shaped support 20, at fixed intervals D. The support is made of flexible material, such as paper or else a plastic. Preferably, the support is coated with a film of an adhesive substance 22, which when it is of self-adhesive type is possibly covered with a protective wrap, such as silicone-coated paper, that is removed before use.

As the support is flexible, it can be presented in the form of a roll. In this case, the ungummed face may possibly be treated so as to be anti-adhesive. While unwinding the support, the film of adhesive material remains on the gummed face and is not transferred.

On the non-adhesive face of the support have been drawn, with ink for example, marks 26 which can be read by an optical reading means. These marks are spaced apart here according to the same pitch D as the labels.

In accordance with another embodiment, not represented, the transponders 14 are mounted directly on the support 20, without the intermediary of a label.

Referring to FIG. 4, the downstream part of a corrugating machine 100 is seen. These machines are well known per se. They cater for the production of corrugated cardboard from paper sheets. A corrugated cardboard panel comprises a first liner sheet, one or more corrugated sheets separated by a plane sheet, and possibly a second liner sheet. The downstream part of the machine 100 represented here comprises a pair of rolls 104 catering for the assembly of the sheets coming from the upstream part. A sheet 110 is applied against the flutes of the assembly constituted by a corrugated sheet 112 and a second liner sheet 114 preassembled upstream. The flutes have been coated with glue previously. After assembly, the ply 120 formed is guided between heating panels 102 so as to dry the glue for bonding the various sheets. The ply 120 on exiting the panels is rigid. It is supported on appropriate bearing means, such as cylinders. Of course, this combination is only an example from among all the possible embodiments of corrugated cardboard. A corrugating machine also comprises, downstream, a cutting knife transverse with respect to its direction of travel. The ply is thus cut into sheets 120′ or semi-finished panels that are stacked for storage, while waiting to be transferred to the conversion machines where they are cut to the shape and to the dimensions of the desired packaging, cartons or tubs.

In accordance with the invention, downstream of the heating panels is disposed a reel 30 for a labels support roll R. The axis of rotation of the roll is crosswise to the travel direction. The support strip 20 is unreeled from the roll and driven about an applicator roll 32 kept bearing against the ply. The support strip 20 is thus applied with pressure to the upper liner sheet of the corrugated cardboard. The support strip 20 is applied to the cardboard, with its face comprising the adhesive against the latter. In this way, the marks 26 drawn on the opposite face of the support are visible. While moving downstream, the cardboard ply travels past a cell 40 for detecting the marks. The cell is linked to an automaton 45 which controls a cutting member 50, itself situated downstream, for the corrugated cardboard panel, in the transverse direction with respect to the travel direction. This cutting member thus cuts the ply 120 of corrugated cardboard into individual panels, 120′.

In this example, the sheets are cut to a length D.

According to another particular embodiment, several, at least two, transponders are placed over one and the same interval of cutting of the cardboard ply. The cut sheet then comprises several transponders lengthwise. During conversion, on platen press or other cutting machine, the sheet is recut in the travel direction into as many sheets of reduced length as there are transponders.

According to another embodiment, at least two transponders are also placed over one and the same interval of cutting of the cardboard ply, with this difference that to each there corresponds its own inherent reading frequency. This sheet is used to make a final packaging which comprises these various transponders with the aim of being able to respond to different reading frequencies.

The machine operates as follows.

The ply 120 of corrugated cardboard exiting the heating station moves in horizontal translation, on its bearing cylinders, up to the cutting member 50. On its journey, it receives the labels 10 with the strip 20; the labels 10 are pitched D apart. The marks 26 trigger the cutting operation by travelling past the detection cell 40. Cutting by the knives 50 is thus ensured between two consecutive labels, without running the risk of spoiling them through an untoward cut.

In the figure, a ply cut into panels of width equal to the breadth of the ply is seen. In accordance with a variant embodiment, not represented, the ply can be cut into plies of smaller breadth by continuous cutting by means of a cutting member disposed in the ply travel direction. If desired, and according to requirements, two reels are disposed in parallel, each supplying a ply of smaller breadth. These are cut into individual panels independently of one another. The intervals D1 and D2 of transverse cutting are not necessarily the same. Each ply has its marks detector, controlling independently of one another, the two cutting members.

Once cut, the individual panels are stored or transported directly as far as a conversion station as is known. A conversion station comprises cutting, slitting and/or scoring means, for forming any known type of packaging, carton or tub; the flat packaging thus made is thereafter stored so as to be shipped to its destinations.

The solution of the invention presents great advantages from the industrial standpoint.

The greatest part of the cost of a radiofrequence label is that of the electronic component and of the antenna. The cost of the support is low and only marginally affects the retail price. Thus the increase in the length of the support per label has a low impact on the final cost.

The method implements moreover techniques which are known and proven. The person skilled in the art knows how to deposit a continuous band on a substrate which is moving in translation. He is also aware of the technique termed cutting to the mark on corrugating machine. This technique is for example already used to cut a corrugated cardboard ply which comprises printed patterns for each panel, cutting being performed between two consecutive printings.

The method of the invention moreover avoids interventions on conversion machines, such as integrated “slotters” or platen presses, whose kinematics and speeds are not compatible with the laying of labels.

1- Method for applying radiofrequence identification transponders (14) to packaging sheets (120′), the sheets being obtained by cuts at intervals D in a band (120) of packaging material, characterized by the fact that
the said transponders (14) having previously been mounted on support (20) consisting of a strip-shaped flexible material with at least one transponder (14) between each interval D, the intervals being defined by marks (26) on the support,
the said support (20) is laid on the band (120) of packaging material lengthwise, in such a manner that the transponders (14) are placed on the band (120) according to the said interval D,
the transponders (14) are secured to the material, and
the band (120) of packaging material is cut into packaging sheets (120′) with respect to the said marks (26).

2- Method according to the preceding claim, according to which the band (120) of packaging material is cut between two successive transponders (14).

3- Method according to claim 1 according to which a support (20) comprising at least two transponders (14) per interval D is used, so as to obtain a sheet after cutting having the said at least two transponders (14).

4- Method according to the preceding claim, the said transponders (14) on one and the same interval exhibiting different characteristics of frequency of use.

5- Method according to claim 3, the sheet being subsequently cut between the said at least two transponders (14).

6- Method according to one of the preceding claims, according to which the transponders (14) are secured to the band (120) of packaging material with the said support (20).

7- Method according to one of the preceding claims, according to which the packaging material is corrugated cardboard.

8- Method according to the preceding claim, according to which the transponders (14) are deposited on the packaging material when the latter is on corrugating machine (100).

9- Method according to the preceding claim, according to which the transponders (14) are deposited on corrugating machine (100) downstream of the station for assembling the elementary sheets (110, 112, 114) constituting the corrugated cardboard.

10- Method according to one of the preceding claims, according to which the band (120) of packaging material being cut into at least two mutually parallel bands, a support with transponders is deposited on each of the parallel bands, it being possible for the intervals to be equal or different.

11- Support of electronic transponders (14) for the implementation of the method according to one of the preceding claims, consisting of a strip-shaped continuous support (20) to which the transponders (14) are fixed, at a rate of at least one per interval D.

12- Support according to the preceding claim comprising an adhesive means for fixing the transponders (14) to the packaging material.
